(19) United States
(12) Patent Application Publication
(10) Pub. No.: US 2016/0223858 A1
(43) Pub. Date: Aug. 4, 2016

(54) LIQUID CRYSTAL DISPLAY DEVICE AND MANUFACTURING METHOD THEREOF

(71) Applicant: SAMSUNG DISPLAY CO., LTD., Yongin-si (KR)

(72) Inventors: Sang-Uk LIM, Yongin-si (KR); Seok Kyu YOON, Asan-si (KR); Sun Hwa LEE, Yongin-si (KR)

(21) Appl. No.: 14/927,220

(22) Filed: Oct. 29, 2015

(30) Foreign Application Priority Data
Feb. 3, 2015 (KR) 10-2015-0016903

(51) Int. Cl. G02F 1/1335

(52) U.S. Cl. CPC G02F 1/133514; G02F 1/133516; G02F 1/133512; G02F 2001/133519

(57) ABSTRACT

A liquid crystal display includes: a first substrate; a second substrate facing the first substrate; a liquid crystal layer formed between the first substrate and the second substrate; and a first color pixel area, a second color pixel area, a third color pixel area, and a fourth color pixel area, wherein the first, second, third, and fourth color pixel areas are formed on one of the first substrate and the second substrate. The first, second, and third color pixel areas respectively include one of a red filter, a green filter, and a blue filter, and the fourth color pixel area includes a white filter. A cross-section of the white filter has a parabolic shape or a semicircular shape.

### CROSS-REFERENCE TO RELATED APPLICATION

This application claims priority to and the benefit of Korean Patent Application No. 10-2015-0016903 filed in the Korean Intellectual Property Office on Feb. 3, 2015, the entire contents of which are incorporated herein by reference.

### BACKGROUND

(a) Technical Field

The present disclosure generally relates to a liquid crystal display including a white pixel, and a manufacturing method thereof.

(b) Description of the Related Art

Liquid crystal displays are widely used in flat panel displays. A liquid crystal display (LCD) typically includes two display panels on which field generating electrodes such as a pixel electrode and a common electrode are formed, and a liquid crystal layer interposed between the two display panels. The LCD can display an image by applying a voltage to the field generating electrodes to generate an electric field over the liquid crystal layer. The electric field determines the alignment directions of liquid crystal molecules in the liquid crystal layer, and controls polarization of incident light passing through the liquid crystal layer, thereby allowing an image to be displayed on the LCD.

Since the liquid crystal display is not self-emissive, a light source is required. The light source may be a separately provided artificial light source or a natural light source. The artificial light source used in the liquid crystal display may include a light emitting diode (LED), a cold cathode fluorescent lamp (CCFL), or an external electrode fluorescent lamp (EEFL). The artificial light source is disposed at a rear surface or a lateral surface of the liquid crystal display to emit light. For example, the light source may be a white light source for emitting white light.

In general, a color filter is used in the liquid crystal display to enable red, green, and blue colors to be displayed. Recently, a liquid crystal display including white pixels in addition to red, green, and blue pixels, has been being developed to increase the luminance thereof.

The above information disclosed in this Background section is only to enhance understanding of the background of the inventive concept and therefore it may contain information that does not form the prior art that is already known in this country to a person of ordinary skill in the art.

### SUMMARY

The present disclosure provides a liquid crystal display and a manufacturing method thereof. The exemplary liquid crystal display has several advantages. For example, a shape of a color filter in the liquid crystal display may be changed to prevent the occurrence of a yellowish defect and to improve luminance. In addition, a visibility difference between a front surface and a lateral surface of the liquid crystal display is improved.

According to an exemplary embodiment of the inventive concept, a liquid crystal display is provided. The liquid crystal display includes: a first substrate; a second substrate facing the first substrate; a liquid crystal layer formed between the first substrate and the second substrate; and a first color pixel area, a second color pixel area, a third color pixel area, and a fourth color pixel area, wherein the first, second, third, and fourth color pixel areas are formed on one of the first substrate and the second substrate, wherein the first, second, and third color pixel areas respectively include one of a red filter, a green filter, and a blue filter, and the fourth color pixel area includes a white filter, and wherein a cross-section of the white filter has a parabolic shape or a semicircular shape.

In some embodiments, a cross-section of the red filter, the green filter, and the blue filter may have a rectangular shape.

In some embodiments, the liquid crystal display may further include a plurality of light blocking members formed between the red filter, the green filter, the blue filter, and the white filter.

In some embodiments, the liquid crystal display may further include an overcoat formed covering the red filter, the green filter, the blue filter, the white filter, and the light blocking members may.

In some embodiments, the liquid crystal display may further include a plurality of pixel electrodes disposed in the first color pixel area, the second color pixel area, the third color pixel area, and the fourth color pixel area.

In some embodiments, the liquid crystal display may further include a light source disposed at a rear surface of one of the first substrate and the second substrate.

According to another embodiment of the inventive concept, a liquid crystal display is provided. The liquid crystal display includes: a first substrate; a second substrate facing the first substrate; a liquid crystal layer formed between the first substrate and the second substrate; and a first color pixel area, a second color pixel area, a third color pixel area, and a fourth color pixel area formed on one of the first substrate and the second substrate, wherein the first, second, and third color pixel areas respectively include one of a red filter, a green filter, and a blue filter, and the fourth color pixel area includes a white filter, and wherein a surface of the white filter is formed having a convex portion and a concave portion.

In some embodiments, a cross-section of the red filter, the green filter, and the blue filter may have a rectangular shape.

In some embodiments, the liquid crystal display may further include: a plurality of light blocking members formed between the red filter, the green filter, the blue filter, and the white filter.

In some embodiments, the liquid crystal display may further include: an overcoat formed covering the red filter, the green filter, the blue filter, the white filter, and the light blocking members.

In some embodiments, a surface of the overcoat may be formed having an embossed shape including the convex portion and the concave portion.

In some embodiments, the liquid crystal display may further include: a plurality of pixel electrodes disposed in the first color pixel area, the second color pixel area, the third color pixel area, and the fourth color pixel area.

According to a further embodiment of the inventive concept, a method of manufacturing a liquid crystal display is provided. The method includes: forming a plurality of light blocking members that separately divide regions for first, second, third, and fourth color pixel areas on a first substrate; forming a red filter, a green filter, and a blue filter respectively on the first, second, and third color pixel areas; performing a hydrophobic treatment on surfaces of the red, green, and blue filters in the first, second, and third color pixel areas, and performing a hydrophilic treatment on a surface of the fourth color pixel area; and forming a white filter in the fourth color pixel area.

In some embodiments, a cross-section of the red filter, the green filter, and the blue filter may have a rectangular shape.

In some embodiments, the method may further include: forming an overcoat to cover the red, green, blue, and white filters, and the light blocking members.

According to one or more of the above exemplary embodiments, a yellowish defect can be prevented, good luminance can be achieved, and a visibility difference between the front and lateral surfaces of a liquid crystal display can be improved by changing a shape of a color filter in the liquid crystal display.

### BRIEF DESCRIPTION OF THE DRAWINGS

FIG. 1 is a top plan view of a liquid crystal display according to a first exemplary embodiment.

FIG. 2 is a cross-sectional view of the liquid crystal display of FIG. 1 taken along line II-II.

FIG. 3 is a top plan view illustrating a white pixel area of the liquid crystal display according to the first exemplary embodiment.

FIG. 4 is a cross-sectional view of the liquid crystal display of FIG. 3 taken along line IV-IV.

FIG. 5 is a cross-sectional view of a liquid crystal display according to a second exemplary embodiment.

FIG. 6 is a cross-sectional view of a liquid crystal display according to a third exemplary embodiment.

FIG. 7 is a cross-sectional view of a liquid crystal display according to a fourth exemplary embodiment.

FIG. 8 is a cross-sectional view of a liquid crystal display according to a fifth exemplary embodiment.

FIGS. 9, 10, and 11 are cross-sectional views sequentially illustrating a method of manufacturing the liquid crystal display according to the first exemplary embodiment.

### DETAILED DESCRIPTION

The inventive concept will be described more fully herein with reference to the accompanying drawings, in which exemplary embodiments are shown. As those skilled in the art would realize, the embodiments may be modified in various ways without departing from the spirit or scope of the present disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be disposed directly on the other element, or with one or more intervening elements being present. In contrast, when an element is referred to as being “directly on” another element, there are no intervening elements present.

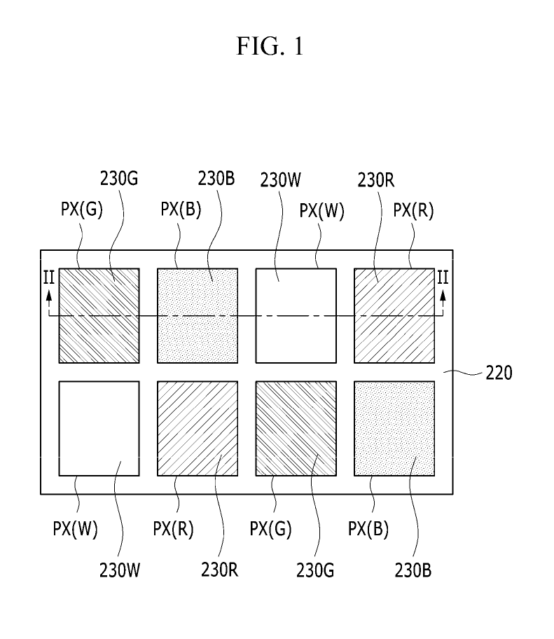

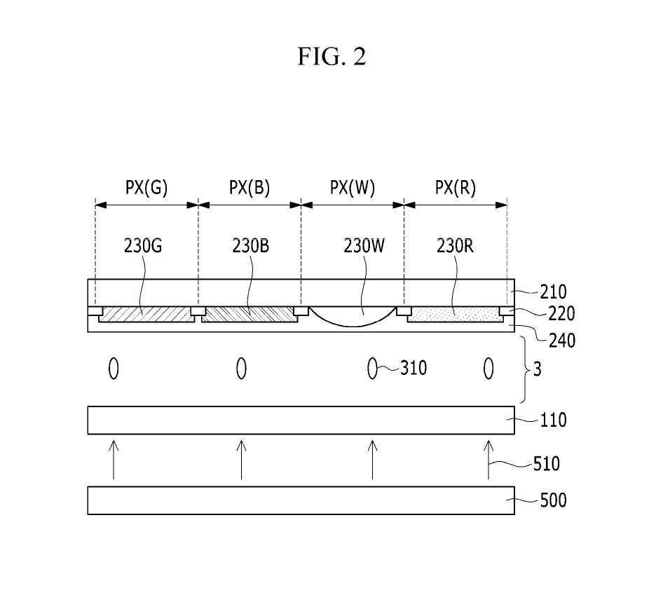

First, a liquid crystal display according to an exemplary embodiment will be described in detail with reference to FIGS. 1 and 2.

FIG. 1 is a top plan view of a liquid crystal display according to a first exemplary embodiment, and FIG. 2 is a cross-sectional view of the liquid crystal display of FIG. 1 taken along line II-II.

Referring to FIGS. 1 and 2, the liquid crystal display includes a first substrate 110 and a second substrate 210 disposed facing each other, and a liquid crystal layer 3 disposed between the first substrate 110 and the second substrate 210.

The first substrate 110 and the second substrate 210 may be made of glass, plastic, or the like. The liquid crystal layer 3 may include a plurality of liquid crystal molecules 310, and may be formed as a positive type or a negative type.

A light source 500 may be disposed on a rear surface of the first substrate 110. The light source 500 may include a light emitting diode (LED) configured to emit light 510. An orientation of the liquid crystal molecules 310 of the liquid crystal layer 3 is determined by an electric field generated between the first substrate 110 and the second substrate 210, and an amount of light passing through the liquid crystal layer 3 varies according to the orientation of the liquid crystal molecules 310. A plurality of color filters 230R, 230G, 230B, and 230W are disposed on the second substrate 210. When the light passing through the liquid crystal layer 3 is incident to the color filters 230R, 230G, 230B, and 230W, a portion of the light passes through the colors filters while the remaining portion of the light is absorbed by the color filters.

For convenience of illustration, the light source 500 is shown disposed on the rear surface of the first substrate 110. However, the inventive concept is not limited thereto. In some other embodiments, the light source 500 may be disposed on a rear surface of the second substrate 210 instead of the rear surface of the first substrate 110.

The liquid crystal display may include a plurality of pixel areas. The pixel areas may be divided into a first color pixel area PX(R), a second color pixel area PX(G), a third color pixel area PX(B), and a fourth color pixel area PX(W). The first color pixel area PX(R), the second color pixel area PX(G), and the third color pixel area PX(B) display different colors, and the colors may be combined to produce a white color. The fourth color pixel area PX(W) may display a white color. For example, the first color pixel area PX(R), the second color pixel area PX(G), the third color pixel area PX(B), and the fourth color pixel area PX(W) may respectively display red, green, blue, and white colors.

However, the inventive concept is not limited thereto. For example, in some other embodiments, the first color pixel area PX(R), the second color pixel area PX(G), the third color pixel area PX(B), and the fourth color pixel area PX(W) may respectively display cyan, magenta, yellow, and white colors.

The color filters 230R, 230G, 230B, and 230W are disposed in the respective pixel areas on the second substrate 210. Specifically, the red filter 230R, the green filter 230G, and the blue filter 230B are respectively disposed in the first color pixel area PX(R), the second color pixel area PX(G), and the third color pixel area PX(B). The red filter 230R may allow only red color light (of the white light) to pass through. The green filter 230G may allow only green color light (of the white light) to pass through. The blue filter 230B may allow only blue color light (of the white light) to pass through.

The white filter 230W may be disposed in the fourth color pixel area PX(W). Since the fourth color pixel area PX(W) is transparent, the white filter 230W may be formed of a photoresist that allows all wavelength bands of the visual rays to pass through. However, it should be noted that the inventive concept is not limited thereto. For example, in some other embodiments, the white filter 230W may be formed of a photoresist that allows only selected wavelength bands of the visual rays to pass through.

Accordingly, the white filter 230W is a filter wherein a wavelength of light passing through the white filter 230W is not substantially changed so that the color of the transmitted light is maintained. However, the inventive concept is not limited thereto. In some other embodiments, the white filter 230W may be a filter wherein a wavelength of light passing through the white filter 230W is changed in a predetermined range according to a characteristic of the white filter 230W.

Each of the pixel areas PX(R), PX(G), PX(B), and PX(W) may have a rectangular shape with two short sides and two long sides. The red filter 230R, the green filter 230G, the blue filter 230B, and the white filter 230W may be respectively formed having a quadrangular flat shape corresponding to the shape of the pixel areas PX(R), PX(G), PX(B), and PX(W).

In some embodiments, a cross-section of the white filter 230W may have a parabolic shape or a semicircular shape.

In the liquid crystal display comprising the color filters 230R, 230G, 230B, and 230W, a first white color can be displayed using a combination of the red filter 230R, the green filter 230G, and blue filter 230B, and a second white color can be displayed using the white filter 230W. In some cases, there may be a difference between the first white color and the second white color if the first and second white colors are not well-balanced.

Furthermore, when the liquid crystal display is viewed laterally, a light path at the lateral side of the flat white filter 230W is longer than a light path at the front side of the flat white filter 230W. As a result, a yellowish defect may occur at the lateral side of the flat white filter 230W.

However, when a cross-section of the white filter 230W is formed having a parabolic shape or a semicircular shape, light path lengths at the lateral and front sides of the white filter 230W may be adjusted such that the light path lengths are similar to each other. Accordingly, the occurrence of the yellowish defect may be prevented.

The red, green, and blue filters 230R, 230G, and 230B excluding the white filter 230W may be formed having a rectangular cross-section.

A plurality of light blocking members 220 may be further disposed at the boundaries between the first color pixel area PX(R), the second color pixel area PX(G), the third color pixel area PX(B), and the fourth color pixel area PX(W). The light blocking members 220 can prevent color mixture, light leakage, and other defects that may occur at the boundaries between the pixel areas PX(R), PX(G), PX(B), and PX(W).

An overcoat 240 may be further disposed on the red filter 230R, the green filter 230G, the blue filter 230B, the white filter 230W, and the light-blocking member 220. The overcoat 240 serves to planarize a top surface of the second substrate 210.

In some embodiments, the white filter 230W may be formed of the same material as the overcoat 240 using the same process.

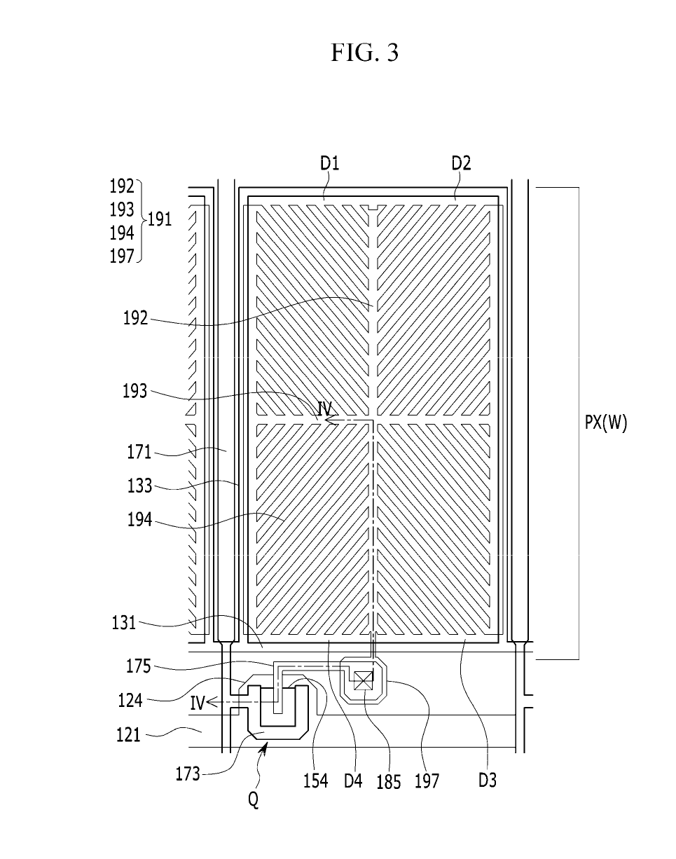

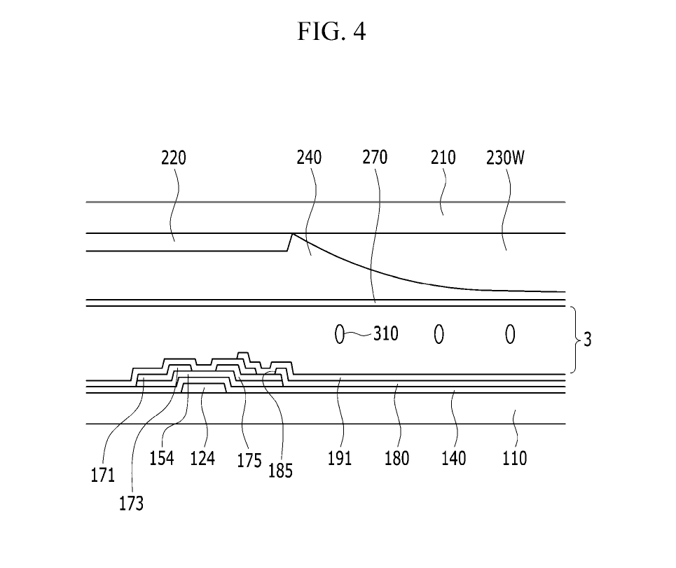

Next, the white pixel area PX(W) of the liquid crystal display according to the first exemplary embodiment will be described in further detail with reference to FIGS. 3 and 4.

FIG. 3 is a top plan view illustrating the white pixel area PX(W) of the liquid crystal display according to the first exemplary embodiment, and FIG. 4 is a cross-sectional view of the liquid crystal display of FIG. 3 taken along line IV-IV.

Referring to FIGS. 3 and 4, a gate line 121 and a storage electrode line 131 are formed on a first substrate 110.

The gate line 121 extends in a substantially horizontal direction and transmits a gate signal. A gate electrode 124 is formed protruding from the gate line 121.

The storage electrode line 131 extends in a direction parallel to the gate line 121, that is, in a horizontal direction, and transmits a predetermined voltage such as a common voltage. A storage electrode 133 is formed protruding from the storage electrode line 131. The storage electrode 133 may be formed surrounding the edges of the fourth color pixel area PX(W).

A gate insulating layer 140 is formed on the gate line 121, the gate electrode 124, the storage electrode line 131, and the storage electrode 133. The gate insulating layer 140 may be made of an inorganic insulating material such as a silicon nitride (SiNx) or a silicon oxide (SiOx). Furthermore, the gate insulating layer 140 may be formed as a single layer or having a multi-layer structure.

A semiconductor 154 is formed on the gate insulating layer 140. The semiconductor 154 is formed overlapping with the gate electrode 124. The semiconductor 154 may be made of amorphous silicon, polycrystalline silicon, a metal oxide, and the like.

An ohmic contact member (not shown) may be further formed on the semiconductor 154. The ohmic contact may be made of a silicide, or a material such as n+ hydrogenated amorphous silicon having a highly doped n-type impurity.

A data line 171, a source electrode 173, and a drain electrode 175 are formed on the semiconductor 154. The source electrode 173 is formed protruding from the data line 171, and the drain electrode 175 is separated from the source electrode 173. The source electrode 173 and the drain electrode 175 are formed overlapping with the gate electrode 124.

The gate electrode 124, the source electrode 173, and the drain electrode 175, together with the semiconductor 154, collectively constitute a thin film transistor Q. A channel of the thin film transistor Q is formed between the source electrode 173 and the drain electrode 175.

A passivation layer 180 is formed on the data line 171, the source electrode 173, the drain electrode 175, and on an exposed portion of the semiconductor 154. A pixel electrode 191 is formed on the passivation layer 180. The pixel electrode 191 may be made of a transparent metal oxide such as indium tin oxide (ITO) or indium zinc oxide (IZO).

The pixel electrode 191 may be generally shaped as a quadrangle. The pixel electrode 191 includes a cross-shaped stem including a horizontal stem portion 193, and a vertical stem portion 192 crossing the horizontal stem portion 193. The pixel electrode 191 further includes a micro-branch portion 194 extending from the horizontal stem portion 193 and the vertical stem portion 192. An extension 197 is formed extending from the quadrangle-shaped pixel electrode 191. The extension 197 is physically and electrically connected to the drain electrode 175 through a contact hole 185, so as to receive a data voltage from the drain electrode 175.

The contact hole 185 is formed through the passivation layer 180. The pixel electrode 191 is connected to the drain electrode 175 through the contact hole 185.

The fourth color pixel area PX(W) is divided into four domains D1, D2, D3, and D4 by the horizontal stem portion 193 and the vertical stem portion 192 of the pixel electrode 191. The micro-branch portion 194 extends obliquely from the horizontal stem portion 193 and the vertical stem portion 192. For example, in the first domain D1, the micro-branch portion 194 extends from the horizontal stem portion 193 or the vertical stem portion 192 in an upward and leftward direction. In the second domain D2, the micro-branch portion 194 extends from the horizontal stem portion 193 or the vertical stem portion 192 in an upward and rightward direction. In the third domain D3, the micro-branch portion 194 extends from the horizontal stem portion 193 or the vertical stem portion 192 in a downward and rightward direction. In the fourth domain D4, the micro-branch portion 194 extends from the horizontal stem portion 193 or the vertical stem portion 192 in a downward and leftward direction.

Each micro-branch portion 194 may form an angle of about 45 or 135 degrees with respect to the gate line 121 or the horizontal stem portion 193. The directions in which the micro-branch portions 194 of two adjacent domains (D1, D2) and (D3, D4) extend may be perpendicular to each other.

The pixel electrode 191 may further include an outer stem surrounding an outer circumference of the fourth color pixel area PX(W).

The white filter 230W is formed on the second substrate 210 and disposed facing the first substrate 110.

The light blocking member 220 is formed at an edge of the fourth color pixel area PX(W). The overcoat 240 is formed on the white filter 230W and the light blocking member 220.

In some embodiments, a cross-section of the white filter 230W may have a parabolic shape or a semicircular shape.

When the liquid crystal display includes the four color filters 230R, 230G, 230B, and 230W, a first white color can be displayed using a combination of the red filter 230R, the green filter 230G, and the blue filter 230B, and a second white color can be displayed using the white filter 230W. In some cases, there may be a difference between the first white color and the second white color if the first and second white colors are not well-balanced.

Furthermore, when the liquid crystal display is viewed laterally, a light path at the lateral side of the flat white filter 230W is longer than the light path at the front side of the flat white filter 230W. Accordingly, a yellowish defect may occur at the lateral side of the flat white filter 230W.

However, when a cross-section of the white filter 230W has a parabolic shape or a semicircular shape, light path lengths at the lateral and front sides of the white filter 230W may be adjusted such that the light path lengths are similar each other. Accordingly, the occurrence of the yellowish defect may be prevented.

A common electrode 270 is formed on the overcoat 240. The common electrode 270 may be made of a transparent metal oxide such as indium tin oxide (ITO) or indium zinc oxide (IZO).

A predetermined voltage such as a common voltage is applied to the common electrode 270. When a data voltage is applied to the pixel electrode 191, an electric field is generated between the pixel electrode 191 and the common electrode 270, and the liquid crystal molecules 310 of the liquid crystal layer 3 disposed therebetween are arranged in a predetermined direction under the influence of the electric field.

Although the above description focuses on the fourth color pixel area PX(W), it is noted that the first, second, or third pixel area PX(R), PX(G), or PX(B) may have a structure similar to that of the fourth color pixel area PX(W). However, unlike the fourth color pixel area PX(W), the red filter 230R is primarily formed in the first pixel area PX(R), the green filter 230G is primarily formed in the second pixel area PX(G), the blue filter 230B is primarily formed in the third pixel area PX(B), and each of the filters 230R, 230G, and 230B may have a rectangular shape.

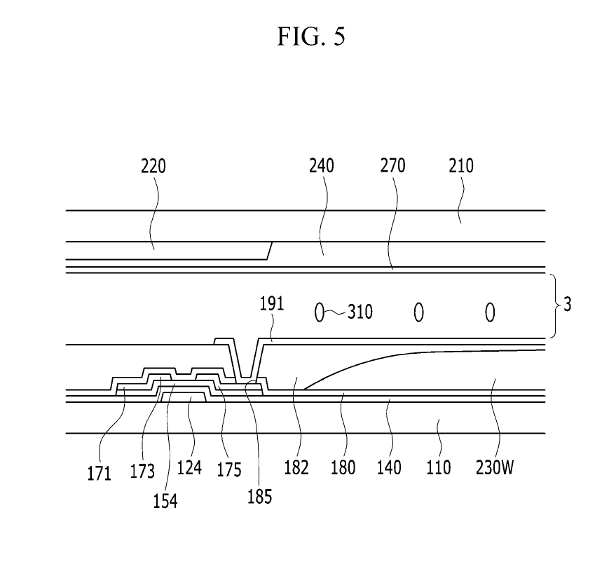

In the above-described embodiments, the color filters 230R, 230G, 230B, and 230W are disposed on the second substrate 210. However, the inventive concept is not limited thereto. In some other embodiments, the color filters 230R, 230G, 230B, and 230W may be disposed on the first substrate 110, as described below with reference to FIG. 5.

FIG. 5 is a cross-sectional view of a liquid crystal display according to a second exemplary embodiment.

The liquid crystal display according to the exemplary embodiment shown in FIG. 5 is similar to the exemplary embodiment shown in FIG. 4 except for the location of the color filters. In the liquid crystal display according to the second exemplary embodiment (shown in FIG. 5), the color filters 230R, 230G, 230B, and 230W are disposed on the first substrate 110. In the interest of brevity, a repeat description of the similar elements will be omitted.

As shown in FIG. 5, a gate electrode 124, a semiconductor 154, a source electrode 173, a drain electrode 175, and a passivation layer 180 are formed on a first substrate 110. A white filter 230W is disposed on the passivation layer 180.

An overcoat 182 is formed on the passivation layer 180 and the white filter 230W, and a pixel electrode 191 is formed on the overcoat 182.

A contact hole 185 is formed through the passivation layer 180 and the overcoat 182. The pixel electrode 191 is connected to the drain electrode 175 through the contact hole 185.

A light blocking member 220, an overcoat 240, and a common electrode 270 are formed on a second substrate 210.

In some embodiments, a cross-section of the white filter 230W in FIG. 5 may have a parabolic shape or a semicircular shape.

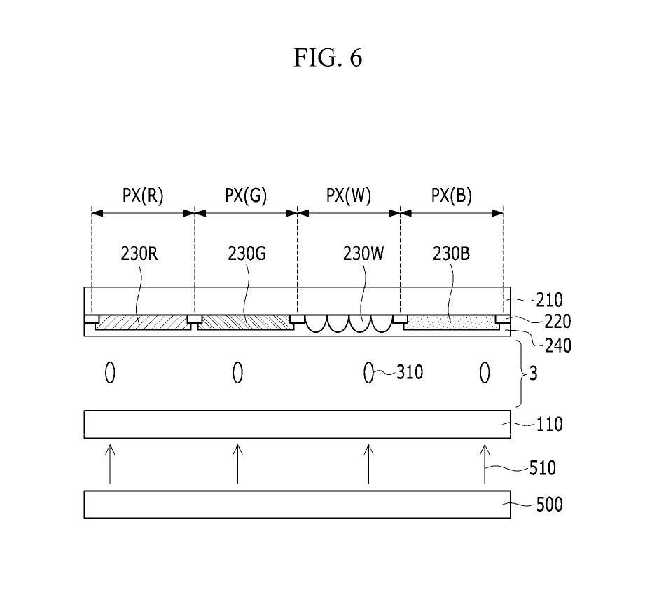

Next, a liquid crystal display according to third, fourth, and fifth exemplary embodiments of the inventive concept will be described in detail with reference to FIGS. 6, 7, and 8.

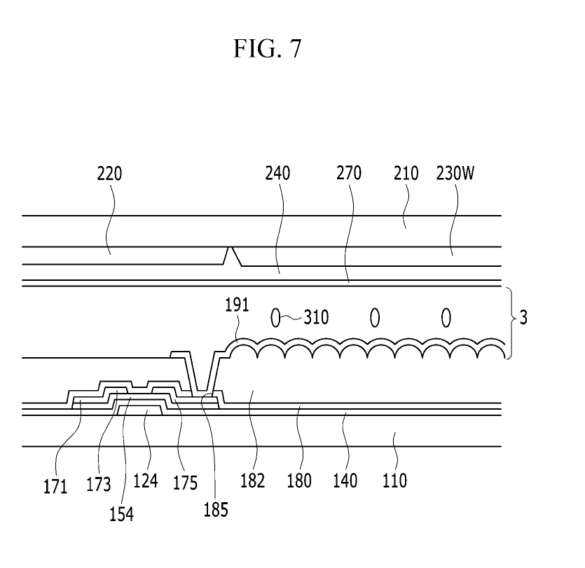

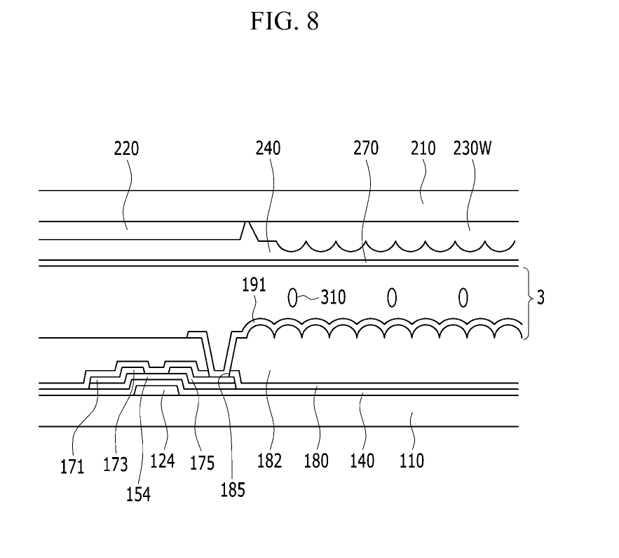

FIG. 6 is a cross-sectional view of a liquid crystal display according to the third exemplary embodiment, FIG. 7 is a cross-sectional view of a liquid crystal display according to the fourth exemplary embodiment, and FIG. 8 is a cross-sectional view of a liquid crystal display according to the fifth exemplary embodiment.

The liquid crystal display according to the exemplary embodiment shown in FIG. 6 is similar to the liquid crystal display according to the exemplary embodiment shown in FIG. 2 except for the shape of the white filter 230W. Accordingly, a repeat description of the similar elements will be omitted.

As shown in FIG. 6, the white filter 230W of the liquid crystal display according to the third exemplary embodiment may be formed having an embossed shape including a convex portion and a concave portion.

When the upper surface of the white filter 230W has a flat surface, a path of light passing through the liquid crystal display from a frontal view may be different from a path of light passing through the liquid crystal display from a lateral view. In the present exemplary embodiment, the light path from the frontal view and the light path from the lateral view of the liquid crystal display may be adjusted to be the same by forming the upper surface of the white filter 230W in the embossed shape including the convex portion and the concave portion. Accordingly, lateral visibility can be improved.

The embossed shape may be formed having a predetermined period, and the period may vary. In the present exemplary embodiment, a shape in which the convex portion and the concave portion are repeatedly arranged along the long sides of the white color pixel area PX(W) is illustrated. However, the inventive concept is not limited thereto. In some other embodiments, the convex portion and the concave portion may be repeatedly arranged along the short sides of the white color pixel area PX(W). In some alternative embodiments, the convex portion and the concave portion may be repeatedly arranged in a matrix form along the long sides and the short sides of the white color pixel area PX(W).

The liquid crystal display according to the exemplary embodiment shown in FIG. 7 is similar to the liquid crystal display of the exemplary embodiment shown in FIG. 4 except for the shape of the white filter 230W and the overcoat 182. Accordingly, a repeat description of the similar elements will be omitted.

As shown in FIG. 7, in the liquid crystal display according to the fourth exemplary embodiment, a white filter 230W is formed having a flat surface. A surface of an overcoat 182 may be formed having an embossed shape including a convex portion and a concave portion. The overcoat 182 may be made of an organic layer.

In the present exemplary embodiment of FIG. 7, a light path from a frontal view and a light path from a lateral view of the liquid crystal display may be adjusted to be the same by forming the upper surface of the overcoat 182 in the embossed shape including the convex portion and the concave portion. Accordingly, lateral visibility can be improved.

The embossed shape of the overcoat 182 may be formed having a predetermined period, and the period may be vary. In the present exemplary embodiment, the shape in which the convex portion and the concave portion are repeatedly arranged along the long sides of the white color pixel area PX(W) is illustrated. However, the inventive concept is not limited thereto. In some other embodiments, the convex portion and the concave portion may be repeatedly arranged along the short sides of the white color pixel area PX(W). In some alternative embodiments, the convex portion and the concave portion may be repeatedly arranged in a matrix form along the long sides and the short sides of the white color pixel area PX(W).

The liquid crystal display according to the exemplary embodiment shown in FIG. 8 is similar to the liquid crystal display according to the exemplary embodiment shown in FIG. 7 except for the shape of the white filter 230W. Accordingly, a repeat description of the similar elements will be omitted.

As shown in FIG. 8, in the liquid crystal display according to the fifth exemplary embodiment, the surfaces of a white filter 230W and an overcoat 182 may be formed having an embossed shape including a convex portion and a concave portion.

In the present exemplary embodiment, a light path from a frontal view and a light path from a lateral view of the liquid crystal display may be adjusted to be the same by forming the respective upper surfaces of the white filter 230W and the overcoat 182 in the embossed shape including the convex portion and the concave portion. Accordingly, lateral visibility can be improved.

The embossed shape of the overcoat 182 and the white filter 230W may be formed having a predetermined period, and the period may vary. In the present exemplary embodiment, the shape in which the convex portion and the concave portion are repeatedly arranged along the long sides of the white color pixel area PX(W) is illustrated. However, the inventive concept is not limited thereto. In some other embodiments, the convex portion and the concave portion may be repeatedly arranged along the short sides of the white color pixel area PX(W). In some alternative embodiments, the convex portion and the concave portion may be repeatedly arranged in a matrix form along the long sides and the short sides of the white color pixel area PX(W).

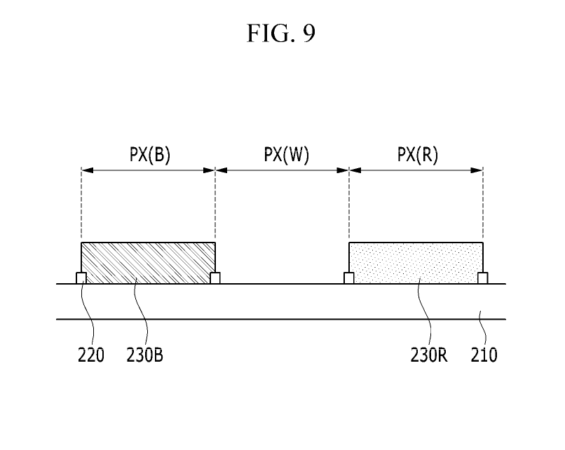

Next, a method of manufacturing the liquid crystal display according to the first exemplary embodiment will be described with reference to FIGS. 9, 10, and 11.

FIGS. 9, 10, and 11 are cross-sectional views sequentially illustrating the method of manufacturing the liquid crystal display according to the first exemplary embodiment.

Referring to FIG. 9, a plurality of light blocking members 220 are formed on a second substrate 210. A red filter 230R, a green filter 230G, and a blue filter 230B are respectively formed in respective pixel areas PX(R), PX(G), and PX(B). Color filters 230R, 230G, and 230B are respectively formed in the first, second, and third color pixel areas PX(R), PX(G), and PX(B), except for the fourth color pixel area PX(W) in which a white filter 230W is formed.

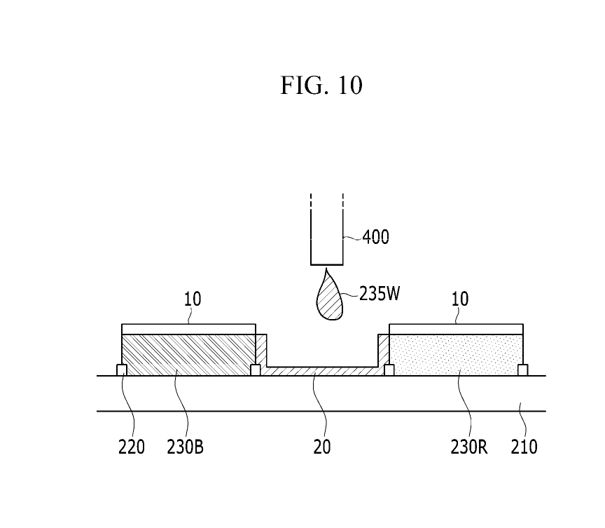

Next, referring to FIG. 10, a hydrophilic treatment 20 is performed on a surface of the fourth color pixel area PX(W) in which the white filter 230W is formed, and a hydrophobic treatment 10 is performed on surfaces of the red filter 230R and the blue filter 230B adjacent to the fourth color pixel area PX(W).

Next, a white-filter material 235W is dispensed using a color filter forming nozzle 400. Specifically, the white-filter material 235W is dispensed onto the surface of the fourth color pixel area PX(W) on which the hydrophilic treatment 20 is performed, so as to form a white filter 230W.

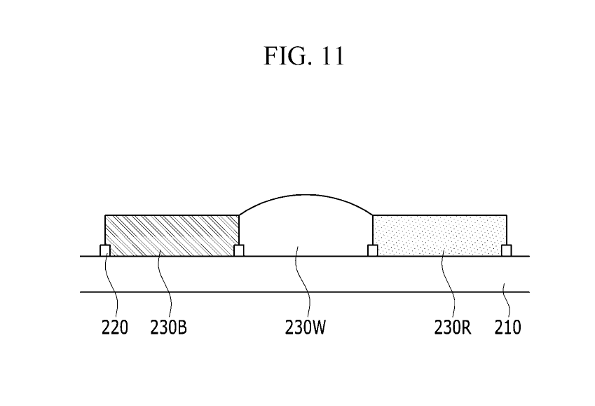

Referring to FIG. 11, the white filter 230W is not formed at the surfaces of the red filter 230R and the blue filter 230B on which the hydrophobic treatment 10 is performed. Instead, the white filter 230W is formed only on the surface of the fourth color pixel area PX(W) on which the hydrophilic treatment 20 is performed. As a result, a cross-sectional surface of the white filter 230W may be formed having a parabolic shape due to a characteristic difference between the surface of the fourth color pixel area PX(W) and the surfaces of the red filter 230R and the blue filter 230B.

It is noted that other processes (that are not illustrated in FIGS. 9, 10, and 11) may be performed using various manufacturing methods known to those skilled in the art, so as to complete the fabrication of the liquid crystal display.

According to one or more of the above exemplary embodiment, a yellowish defect may be prevented, good luminance may be achieved, and a visibility difference between the front and lateral surfaces of the liquid crystal display can be improved by changing a shape of a color filter (e.g., white filter) in the liquid crystal display.

While the inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display, comprising:
a first substrate;
a second substrate facing the first substrate;
a liquid crystal layer formed between the first substrate and the second substrate; and
a first color pixel area, a second color pixel area, a third color pixel area, and a fourth color pixel area, wherein the first, second, third, and fourth color pixel areas are formed on one of the first substrate and the second substrate,
wherein the first, second, and third color pixel areas respectively include one of a red filter, a green filter, and a blue filter, and the fourth color pixel area includes a white filter, and
wherein a cross-section of the white filter has a parabolic shape or a semicircular shape.

2. The liquid crystal display of claim 1, wherein a cross-section of the red filter, the green filter, and the blue filter has a rectangular shape.

3. The liquid crystal display of claim 2, further comprising:
a plurality of light blocking members formed between the red filter, the green filter, the blue filter, and the white filter.

4. The liquid crystal display of claim 3, further comprising:
an overcoat formed covering the red filter, the green filter, the blue filter, the white filter, and the light blocking members.

5. The liquid crystal display of claim 4, further comprising:
a plurality of pixel electrodes disposed in the first color pixel area, the second color pixel area, the third color pixel area, and the fourth color pixel area.

6. The liquid crystal display of claim 1, further comprising:
a light source disposed at a rear surface of one of the first substrate and the second substrate.

7. A liquid crystal display, comprising:
a first substrate;
a second substrate facing the first substrate;
a liquid crystal layer formed between the first substrate and the second substrate; and
a first color pixel area, a second color pixel area, a third color pixel area, and a fourth color pixel area formed on one of the first substrate and the second substrate,
wherein the first, second, and third color pixel areas respectively include one of a red filter, a green filter, and a blue filter, and the fourth color pixel area includes a white filter, and
wherein a surface of the white filter is formed having a convex portion and a concave portion.

8. The liquid crystal display of claim 7, wherein a cross-section of the red filter, the green filter, and the blue filter has a rectangular shape.

9. The liquid crystal display of claim 8, further comprising:
a plurality of light blocking members formed between the red filter, the green filter, the blue filter, and the white filter.

10. The liquid crystal display of claim 9, further comprising:
an overcoat formed covering the red filter, the green filter, the blue filter, the white filter, and the light blocking members.

11. The liquid crystal display of claim 10, wherein a surface of the overcoat is formed having an embossed shape including the convex portion and the concave portion.

12. The liquid crystal display of claim 11, further comprising:
a plurality of pixel electrodes disposed in the first color pixel area, the second color pixel area, the third color pixel area, and the fourth color pixel area.

13. A method of manufacturing a liquid crystal display, comprising:
forming a plurality of light blocking members that separately divide regions for first, second, third, and fourth color pixel areas on a first substrate;
forming a red filter, a green filter, and a blue filter respectively on the first, second, and third color pixel areas;
performing a hydrophobic treatment on surfaces of the red, green, and blue filters in the first, second, and third color pixel areas, and performing a hydrophilic treatment on a surface of the fourth color pixel area; and
forming a white filter in the fourth color pixel area.

14. The method of claim 13, wherein a cross-section of the red filter, the green filter, and the blue filter has a rectangular shape.

15. The method of claim 14, further comprising:
forming an overcoat to cover the red, green, blue, and white filters, and the light blocking members.
